(19) United States
(12) Patent Application Publication
(10) Pub. No.: US 2023/0022777 A1
(43) Pub. Date: Jan. 26, 2023

(54) METHOD AND DEVICE FOR CREATING A MACHINE LEARNING SYSTEM INCLUDING A PLURALITY OF OUTPUTS

(71) Applicant: Robert Bosch GmbH, Stuttgart (DE)

(72) Inventors: Benedikt Sebastian Staffler, Tuebingen (DE); Jan Hendrik Metzen, Boeblingen (DE)

(21) Appl. No.: 17/861,607

(22) Filed: Jul. 11, 2022

(30) Foreign Application Priority Data
Jul. 23, 2021 (DE) 10 2021 207 937.7

(51) Int. Cl. G06N 3/04; G06V 10/82; G06V 10/84

(52) U.S. Cl. CPC G06N 3/04; G06V 10/82; G06V 10/84

(57) ABSTRACT

A method for creating a machine learning system, which is configured for segmentation and object detection. The method includes: providing a directed graph, selecting a path through the graph, at least one additional node being selected from a subset and a path being selected through the graph from the input node along the edges via the additional node up to the output node, the path initially being drawn as a function of probabilities of the edges, which defines a drawing probability of all architectures within the graph, creating a machine learning system as a function of the selected path and training the created machine learning system.

### CROSS REFERENCE

The present application claims the benefit under 35 U.S.C. § 119 of German Patent Application No. 10 2021 207 937.7 filed on Jul. 23, 2021, which is expressly incorporated herein by reference in its entirety.

### FIELD

The present invention relates to a method for creating a machine learning system, for example, for segmentation and object detection, a corresponding computer program and a machine-readable memory medium including the computer program.

### BACKGROUND INFORMATION

The aim of an architecture search for neural networks is to fully automatically find a preferably good network architecture in terms of a key performance indicator/metric for a predefined data set.

In order to design the automatic architecture search in a computationally efficient manner, various architectures in the search space may share the weights of their operations as, for example, in a One-Shot NAS model, described by Pham, H., Guan, M. Y., Zoph, B., Le, Q. V., & Dean, J. (2018), “Efficient neural architecture search via parameter sharing,” arXiv preprint arXiv: 1802.03268.

The One-Shot model in this case is typically constructed as a directed graph, in which the nodes represent data and the edges represent operations, which represent a calculation rule that converts the input node of the edge into the output node. The search space in this case is made up of subgraphs (for example, paths) in the One-Shot model. Since the One-Shot model may be very large, individual architectures may be drawn, in particular, randomly from the One-Shot model for the training such as, for example, described by Cai, H., Zhu, L., & Han, S. (2018), “Proxylessnas: Direct neural architecture search on target task and hardware,” arXiv preprint arXiv:1812.00332. This typically occurs by drawing a single path from an established input node to an output node of the network such as, for example, described by Guo, Z., Zhang, X., Mu, H., Heng, W., Liu, Z., Wei, Y., & Sun, J. (2019), “Single path one-shot neural architecture search with uniform sampling,” arXiv preprint arXiv:1904.00420.

For particular tasks such as object detection or in the case of multi-task networks, it is necessary for the network to include multiple outputs. In this case, gradient-based training of the complete One-Shot model may be modified for this case such as, for example, described by Chen, W., Gong, X., Liu, X., Zhang, Q., Li, Y., & Wang, Z. (2019), “FasterSeg: Searching for Faster Real-Time Semantic Segmentation,” arXiv preprint arXiv:1912.10917. This in turn is not memory-efficient, however and does not show the drawing of architectures with branches and with different outputs during the training within the scope of the architecture search.

The authors Cai, et al. describe in their paper “ProxylessNAS: Direct Neural Architecture Search on Target Task and Hardware,”, retrievable online at: https://arxiv.org/abs/1812.0332, an architecture search, which takes hardware properties into account.

### SUMMARY

The present invention improves the architecture search for multi-task networks including multiple outputs, whose architectures include multiple paths by drawing paths from a One-Shot model at the start of the architecture search without implicitly favoring individual paths. In this way, all architectures of the search space are initially drawn with an equal probability and the search space is thus impartially explored. This has the advantage that ultimately more superior architectures may be found for multi-task networks, which would not be discovered during normal initialization of the (draw) probabilities of the edges and/or nodes of the One-Shot model.

In one first aspect, the present invention relates to a computer-implemented method for creating a machine learning system, which is configured for the segmentation and object detection of images, the machine learning system including an input for receiving the image and one or multiple outputs, one first output outputting the segmentation of the image and one second output outputting the object detection. The second output may alternatively output another object description of the objects on the image, such as an object classification.

In accordance with an example embodiment of the present invention, the method includes the following steps: providing a directed graph, the directed graph including an input and output node and a plurality of further nodes. It is noted that it is also possible that the graph includes a plurality of input nodes and/or output nodes. The input and output nodes are connected via the further nodes with the aid of directed edges and the nodes represent data and the edges represent operations, which may be calculation rules that convert a first node of the edges into a further node connected to the respective edge. It is noted that the assignment of the data and calculation rules may also be reversed.

The edges are each assigned a probability, which characterizes with what probability the respective edge is drawn, in particular, when selecting a path through the graph. The selection of the path is preferably a random, in particular iterative, drawing of the edges as a function of their probabilities.

This is followed by a selection of a path through the graph. In the process, a subset is initially determined from the plurality of the further nodes, which all satisfy a predefined property, for example, with respect to a data resolution, or a depth of the nodes relative to the input node, in order to ensure a predefined receptive field. At least one additional node (Node of Interest, NOI) is selected from this subset, which may serve directly as a second output. A path through the graph from the input node along the edges via the additional node (NOI) up to the output node is thereupon selected. The path may be understood here to mean a sequence of selected nodes of the directed graph, in which in each case two consecutive nodes are connected by one edge. The path in this case may fully characterize the architecture if the architecture includes only one path through the directed graph. It is also possible that the path describes only a part of the architecture, namely when the architecture includes multiple paths through the graph.

It is noted that this additional node may serve as an output and here, for example, an object classification is output, or that an object classification head (detection head) may be connected at this output, which then ascertains the object classification, in particular, object description, as a function of the output of the additional node.

In accordance with an example embodiment of the present invention, the selection of the path may take place iteratively, at each node the following edge being randomly selected as a function of its assigned probability from the possible following edges that are connected to this node. This process is also referred to be below as drawing the path. The path thus represents a direct connection of the input node to the output node.

If the architecture is to include multiple paths, correspondingly multiple repetitions of the preceding step “selecting a path” may take place and a creation of the machine learning system may subsequently take place based on the multiple drawn paths.

In accordance with an example embodiment of the present invention, a creation of a machine learning system then follows as a function of the architecture corresponding to the selected paths and training of the created machine learning system, adapted parameters of the machine learning system being stored in the corresponding edges of the directed graph and the probabilities of the edges of the architecture being adapted. The adaptation of the probabilities may take place in this case via a so-called Black-Box optimizer, which applies the REINFORCE algorithm, for example, (see in this regard, for example, the above-mentioned paper “ProxylessNAS”), in order to estimate gradients for adapting the probabilities of the edges.

The steps of selecting the path/the paths and creating the machine learning system as well as the training may be carried out multiple times in succession, preferably until a change of the parameters is sufficiently small.

The drawing of the path in the last step, in particular after the optimization of the probabilities of the edges, may take place randomly or the edges with the highest probabilities are specifically selected.

In accordance with the present invention, a particular feature of the method is that the directed graph is provided in such a way that the probabilities of the edges are initially set at one value, so that all paths through the directed graph, in particular architectures, are drawn with equal probability. “Initially” may be understood here to mean that this initialization of the probabilities of the edges takes place before the first step of training is carried out. During training, these probabilities may be adapted so that after the training process, high probabilities of the edges signal that these edges are relevant for the architecture of the machine learning system. This particular initializing of the probabilities yields the advantage that as a result of the initial normalization of the probabilities before the training, it is ensured that an exploration of all possible architectures is impartially carried out. This results in the advantageous effect that as a result of the particular initializing, better architectures may be discovered, which would not have been identified without the normalization, since these are initially not explored or only insufficiently explored.

Thus, it may be said that the provided method has the advantage that with this method, a particularly efficient machine learning system, in particular, an artificial neural network, may be discovered for multi-task tasks for image processing (for example, gesture recognition or object distance estimation, etc.).

In addition or alternatively, the tasks for the artificial neural network may be as follows: natural language processing, autoencoder, generative models, etc., the different outputs each characterizing different properties of the input signal with respect to the task.

In accordance with an example embodiment of the present invention, it is provided that for each node of the subset, a total number of first subpaths from the respective node of the subset up to the input node and a total number of second subpaths to the output node are counted. The probabilities of those edges contained in the first subpaths are preferably ascertained as a function of the total number of the first subpaths and the probabilities of those edges contained in the second subpaths are ascertained as a function of the total number of the second subpaths. For example, the probabilities of those edges contained in the first subpaths may be set in each case initially to a number of the possible paths, which connect the input node to the respective node of the subset and which extend over the respective edge, divided by the total number of the first subpaths. In the same way, the probabilities of those edges contained in the second subpaths are set in each case initially to a number of the possible paths, which connect the output node to the respective node of the subset and which extend over the respective edge, divided by the total number of the second subpaths.

It is noted that the ascertainment of the total number of the subpaths may take place in such a way that one first subpath is initially created starting from the additional node (NOI) backwards through the graph to the input node, and one second subpath is created from the additional node (NOI) to the output node. This procedure is then repeated until all possible first and second subpaths have been detected. For this purpose, it is noted that the first subpath and the second subpath together result in the path.

The separate searching of first and second subpaths and the related procedure in order to achieve the normalization of the draw probabilities has the advantage that with respect to the corresponding NOI, it is possible to thereby select the suitable probabilities. Furthermore, this procedure may be carried out in parallel, since the separate searching of the subpaths is independent of one another. The method may thus be particularly easily carried out on parallel computing architectures.

It is further provided that the further nodes of the subset, all of which satisfy a predefined property with respect to a data resolution, are also each assigned a probability, this probability being normalized. The probabilities of the nodes of the subset are, in particular, normalized in such a way that the drawing of a path starting with the drawing of a node of the subset and then drawing of the path results in an equally probable drawing of all possible paths. The normalization of the probabilities of the nodes of the subset preferably takes place regardless of the normalization of the probabilities of the edges. “Normalized” may be understood to mean that a drawing of the respective elements is equally probable, i.e., initially there is no preference for certain NOIs and/or edges and/or paths present.

Identical to the probabilities of the edges, when drawing the path, the additional node (NOI) is drawn as a function of its assigned probability. Furthermore, this probability is also adapted during training, for example, with the Black-Box optimizer.

In accordance with an example embodiment of the present invention, it is further provided that the probabilities of the nodes of the subset of the further nodes are initially set to the probability that the number of paths through the respective node of the subset of the further nodes divided by the total number of paths through the directed graph is set.

In other words, the probability for the drawing of the nodes of the subset is then adjusted to the number of paths through the respective node of the subset divided by the total number of paths through each of the nodes of the subset.

Applying the approach of the separate searching of first and second subpaths, the probability of the nodes of the subset may be defined by

$$P ( s ) = \frac{{N}_{s}^{A} {N}_{s}^{D}}{{\sum }_{s} {N}_{s}^{A} {N}_{s}^{D}} ,$$

the number of first subpaths representing Nₛ^{A} and the number of second subpaths representing Nₛ^{D}
through the considered node s of the subset.

Based on the probabilities of the edges and/or the nodes of the subset, a softmax function and the edges/nodes are then preferably randomly drawn as a function of the outputs of the softmax function. This has the advantage that the softmax function guarantees that an accumulation of the probabilities of the edges/nodes of the subset always yields 1. This advantage produces the advantageous effect that the probabilistic character of the drawing of the paths is maintained and an optimal architecture is thus more reliably discovered.

An advantage of a normalization of the probabilities of the additional nodes (NOIs) is that a full equal treatment of all possible architectures in the One-Shot model is achieved as a result, in particular, any architecture with a probability of one over the entire number of possible architectures of the One-Shot model may be drawn.

In accordance with an example embodiment of the present invention, it is further provided that the probabilities of the nodes (NOIs) of the subset of the further nodes of the graph are initially set to the same probability that all nodes of the subset are initially drawn with the same probability. As a result, no longer are all architectures equally probable, but only all architectures that have the same NOIs. Nevertheless, it has been found that this configuration in numerous applications also results in good architectures. The previous step may thus be omitted, namely that the probability of the additional nodes (NOIs) is ascertained as a function of the number of paths through the additional nodes (NOIs).

In accordance with an example embodiment of the present invention, it is provided that at least two additional nodes (NOI) are selected and the architecture includes at least two paths, each of which extends via one of the additional nodes to the output node. The architecture thus includes at least one branch, according to which pieces of information when propagated through the machine learning system arrive by the different ways to the outputs of the machine learning system. The second additional node may output a further image property. The two paths may be created independently of one another from the input node to the additional nodes starting at the additional nodes up to the input node. It may be said that a subgraph is determined, which effectively describes at least two intersecting paths or one splitting path through the graph. It is further noted that the paths may each be made up of a first and a second subpath and may be drawn accordingly.

In accordance with an example embodiment of the present invention, it is further provided that when a second path of the two paths meets the previously drawn first path of the two paths, the remaining section of the first path is used for the second path.

In accordance with an example embodiment of the present invention, it is further provided that further paths up to the output node are created starting from the additional nodes. It is noted that the paths together result in a subgraph of the directed graph.

In accordance with an example embodiment of the present invention, it is further provided that further paths are drawn independently of one another, and when the paths meet, the previously drawn path continues to be used.

An advantage of this is that by trend more optimal architectures that are smaller may be discovered with this procedure.

In accordance with an example embodiment of the present invention, it is further provided that a cost function is optimized during the training of the machine learning system, the cost function including a first function, which evaluates an efficiency of the machine learning system with respect to its segmentation and object recognition/object description, and including a second function, which estimates a latency or the like of the machine learning system as a function of a length of the path and of the operations of the edges.

In accordance with an example embodiment of the present invention, it is further provided that when creating the machine learning system, at least one output layer is appended to the additional node (NOI). The output layer is preferably a softmax layer.

In further aspects, the present invention relates to a computer program, which is configured to carry out the above method and to a machine-readable memory medium, on which this computer program is stored.

### BRIEF DESCRIPTION OF THE DRAWINGS

Specific embodiments of the present invention are explained in greater detail below with reference to the figures.

FIG. 1 schematically shows a One-Shot model including an input and output node as well as two ‘Nodes of Interest’ (NOI).

FIG. 2 schematically shows a back-directed drawing of a first path from first NOI to the input.

FIG. 3 schematically shows a back-directed drawing of a second path from the second NOI to the input.

FIG. 4 schematically shows a back-directed drawing of the second path from the second NOI to the input with a stop.

FIG. 5 schematically shows a forward-directed drawing of two paths starting with the first path to the output.

FIG. 6 schematically shows a representation of an initial assignment of normalized probabilities of edges of the One-Shot model.

FIG. 7 schematically shows a representation of a flowchart of one specific embodiment of the present invention.

FIG. 8 schematically shows a representation of an actuator control system, according to the present invention.

FIG. 9 shows one exemplary embodiment for controlling an at least semi-autonomous robot, according to the present invention.

FIG. 10 schematically shows one exemplary embodiment for controlling a manufacturing system, according to the present invention.

FIG. 11 schematically shows one exemplary embodiment for controlling an access system, according to the present invention.

FIG. 12 schematically shows one exemplary embodiment for controlling a monitoring system, according to the present invention.

FIG. 13 schematically shows one exemplary embodiment for controlling a personal assistant, according to the present invention.

FIG. 14 schematically shows one exemplary embodiment for controlling a medical imaging system, according to the present invention.

FIG. 15 shows one possible structure of a training device, according to the present invention.

### DETAILED DESCRIPTION OF EXAMPLE EMBODIMENTS

In order to find good architectures of deep neural networks for a predefined data set, automatic methods for the architecture search, so-called neural architecture search methods, may be applied. For this purpose, a search space of possible architectures of neural networks is explicitly or implicitly defined.

The term “operation” will be used below for describing a search space, which describes a calculation rule that converts one or multiple n-dimensional input data tensors into one or multiple output data tensors and, in the process, may have adaptable parameters. In image processing, operations used are, for example, frequently convolutions with various kernel sizes and different types of convolutions (regular convolution, depthwise-separable convolution) and pooling operations.

Furthermore, a calculation graph (the so-called One-Shot model) will be defined, which includes all architectures in the search space as subgraphs. Since the One-Shot model may be very large, individual architectures may be drawn from the One-Shot model for the training. This occurs typically by drawing individual paths from an established input node to an established output node of the network.

In the simplest case, when the calculation graph is made up of a chain of nodes, each of which may be connected via various operations, it is sufficient to draw the operation for two consecutive nodes each, which connects them.

If the One-Shot model is more generally a directed graph, a path may be iteratively drawn by starting at the input, the next node and the connecting operation are then drawn, and this procedure is then continued iteratively up to the target node.

The One-Shot model with drawing may then be trained by drawing an architecture for each mini-batch and by adapting the weights of the operations in the drawn architecture with the aid of a standard gradient step method. Finding the best architecture may take place either as a separate step after the training of the weights or may be carried out alternatingly with the training of the weights.

In order to draw architectures from a One-Shot model, which has branches and multiple outputs, a sampling model may be used in one specific embodiment for paths in the opposite direction. For this purpose, one path may be drawn for each output of the One-Shot model, which leads, starting from the output, to the input of the One-Shot model. For drawing the paths, the transposed One-Shot model may be considered for this purpose, in which all directed edges point in the opposite direction as in the original One-Shot model.

Once the first path has been drawn, it may happen that the next path reaches a node of the previous path. In this case, the drawing of the instantaneous path may be terminated, since a path from the shared node to the input already exists. Alternatively, it is possible to nevertheless draw the path further and to possibly obtain a second path to the input node.

In addition, the case is to be considered that the drawn architectures include one or multiple node(s) of the One-Shot model, which is/are not situated at the full depth of the network and is/are referred to below as NOI (“Nodes of Interest”), as well as an output at full depth of the One-Shot model. In this case, the creation of the path may take place by a back-directed drawing for the NOIs in order to connect these to the input. In addition, a forward-directed drawing is also carried out for each NOI, which leads to the output of the One-Shot model. As in the case of the back-directed drawing, the drawing in the case of the forward-directed drawing may be stopped once a path is reached that already leads to the output.

As an alternative to the back-directed drawing, a purely forward-directed drawing may take place by drawing for each NOI a path from the input to the corresponding NOI. This is achieved in that the drawing is carried out only on the subgraph, which is made up of all nodes that lie on a path from the input of the network to the instantaneous NOI, as well as all edges of the One-shot model between these nodes.

One exemplary embodiment is a multi-task network for object detection and semantic segmentation. The NOIs in this case are nodes at which an object classification output (detection head or object detection head) may be attached. In addition, one more output is used for the semantic segmentation at the output at the full depth of the network.

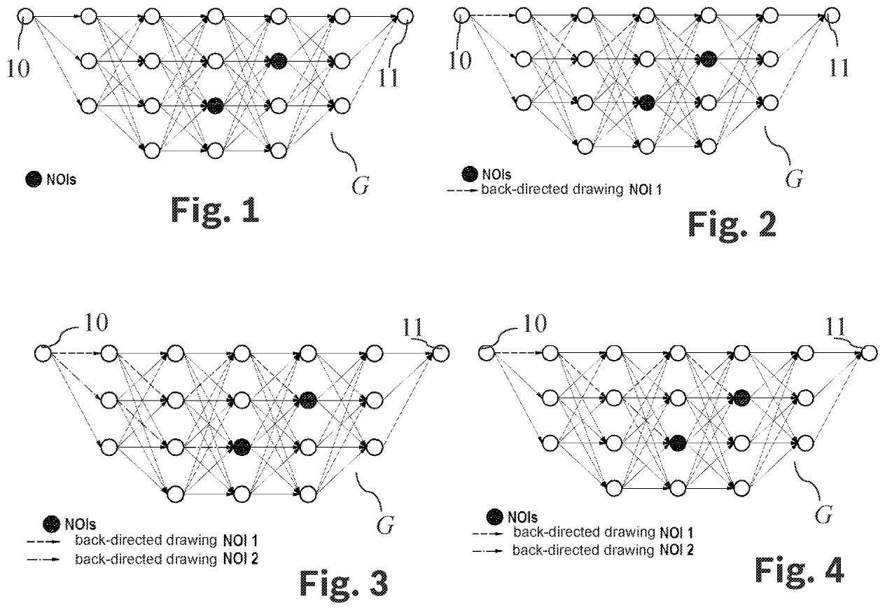

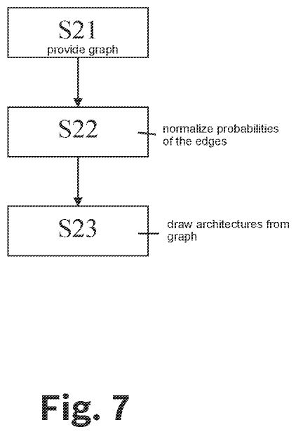

The automatic architecture search initially requires the creation of a search space (S21 in FIG. 7), which is constructed here in the form of a One-Shot model G. The One-Shot model in this case contains an input node 10, an output node 11 and multiple nodes in the middle (i.e., not at full depth) of the model, which must be part of the drawing architecture and are referred to as NOI (Nodes of Interest). The One-Shot model in this case is designed in such a way that all paths that start at the input node lead to the output node (cf. FIGS. 1 through 5).

For each node in G, a probability distribution across the outgoing edges is defined. For each node and for each path, preferably for each set of NOIs, a separate probability distribution may be defined within one architecture. This means, the different paths within one architecture use different probabilities. In addition, the transposed One-Shot model Gₜ is considered, which has the same node, but all directed edges point in the reverse direction. On Gₜ, a probability distribution across the outgoing edges is also introduced for each node (this corresponds to a probability distribution across incoming edges in G).

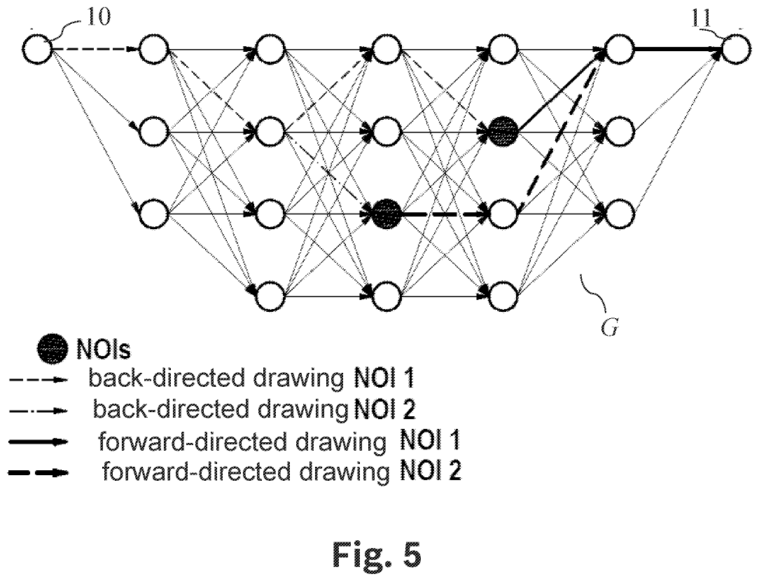

For the back-directed drawing, a path is drawn in Gₜ for the first NOI (23 in FIG. 7), which leads from the NOI to the input of the One-Shot model (cf. FIG. 2). This is repeated iteratively for all further NOIs (cf. FIG. 3), the drawing of the individual paths being capable of being stopped once a node of a previous path to the input is reached (cf. FIG. 4). For the forward-directed drawing, a path is drawn in G for the first NOI, which leads from the NOI to the output of the One-Shot model. This is repeated iteratively for all further NOIs, the drawing of the individual paths being capable of being stopped once a node of a previous path to the output is reached (cf. FIG. 5).

FIG. 5 schematically shows a forward-directed drawing of two paths starting with the first NOI to the output. Drawing the path from the second NOI is stopped in this case since a node from the path of the first NOI has been reached. The overall drawn architecture thus contains both NOIs as well as the output node of the One-Shot model.

With each drawing of an architecture, the NOIs may vary, since these NOIs may also be randomly drawn.

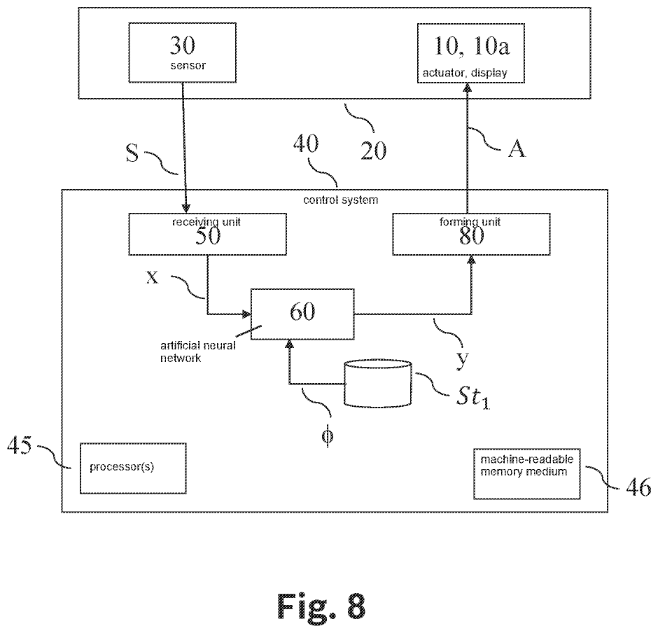

Based on graph G, an artificial neural network 60 (depicted in FIG. 8) may then be created and used as explained below.

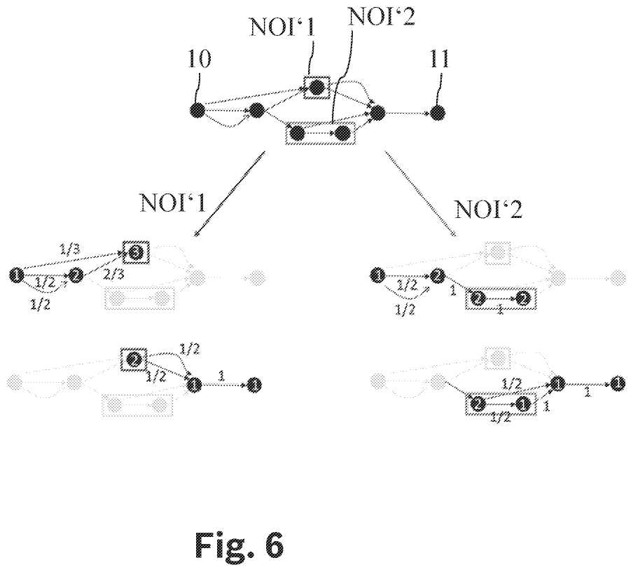

FIG. 6 schematically shows a representation of an initial assignment of normalized probabilities of the edges of a simple One-Shot model. For example, two NOIs are selected, NOI′1 including one node and NOI′2 including two nodes. For each of the NOIs, subpaths are then initially counted backwards to input node 10. This results here in 3 subpaths for NOI′1. Each edge of these subpaths is then assigned a normalized probability, so that each of these subpaths is drawn with equal probability. Since just two of the three subpaths extend over the two incoming edges of NOI′1 and only one of the three subpaths extends over the other incoming edge, these edges are assigned a probability of ⅓ and ⅔. As depicted below, the same procedure is then carried out for the forward-directed drawing of NOI′1 to output node 11. The same procedure is further also carried out for both nodes in NOI′2.

FIG. 7 schematically shows a flowchart of a method for creating a machine learning system using the above-explained procedure for initializing the probabilities as well as for drawing architectures from graph G.

The method may start with step S21, in which graph G is provided.

This is followed by step S22. In this step, the probabilities of the edges as explained in FIG. 6 are normalized.

Step S23 then follows. In this step, the architectures are drawn from the graph as a function of the probabilities of the edges. This is followed by the steps of training the drawn architecture as well as of the transfer of the optimized parameters and probabilities as a result of the training into the graph.

FIG. 8 shows an actuator 10 in its surroundings 20 in interaction with a control system 40. Surroundings 20 are detected at preferably regular temporal intervals in a sensor 30, in particular, in an imaging sensor such as a video sensor, which may also be provided as a plurality of sensors, for example, a stereo camera. Other imaging sensors are also possible such as, for example, radar, ultrasound or LIDAR. A thermal imaging camera is also possible. Sensor signal S—or in the case of multiple sensors, one sensor signal S each—of sensor 30 is conveyed to control system 40. Control system 40 thus receives a sequence of sensor signals S. Control system 40 ascertains therefrom activation signals A, which are transferred to actuator 10.

Control system 40 receives the sequence of sensor signals S of sensor 30 in an optional receiving unit 50, which converts the sequence of sensor signals S into a sequence of input images x (alternatively, each sensor signal S may also be directly adopted as input image x). Input image x may, for example, be a section or a further processing of sensor signal S. Input image x includes individual frames of a video recording. In other words, input image x is ascertained as a function of sensor signal S. The sequence of input images x is fed to a machine learning system, in the exemplary embodiment, to an artificial neural network 60, which has been created, for example, according to the method according to FIG. 7.

Artificial neural network 60 is preferably parameterized by parameters ϕ, which are stored in a parameter memory St₁ and are provided by the latter.

Artificial neural network 60 ascertains from input images x output variables y. These output variables y may include, in particular, a classification and semantic segmentation of input images x. Output variables y are fed to an optional forming unit 80, which ascertains therefrom activation signals A, which are fed to actuator 10 in order to activate actuator 10 accordingly. Output variable y includes pieces of information about objects that sensor 30 has detected.

Actuator 10 receives activation signals A, is activated accordingly and carries out a corresponding action. Actuator 10 in this case may include a (not necessarily structurally integrated) activation logic, which ascertains a second activation signal from activation signal A, with which actuator 10 is then activated.

In further specific embodiments, control system 40 includes sensor 30. In still further specific embodiments, control system 40 includes alternatively or in addition also actuator 10.

In further preferred specific embodiments, control system 40 includes a singular or a plurality of processors 45 and at least one machine-readable memory medium 46, on which instructions are stored which, when they are carried out on processors 45, prompt control system 40 to carry out the method according to the present invention.

In alternative specific embodiments, a display unit 10a is provided alternatively or in addition to actuator 10.

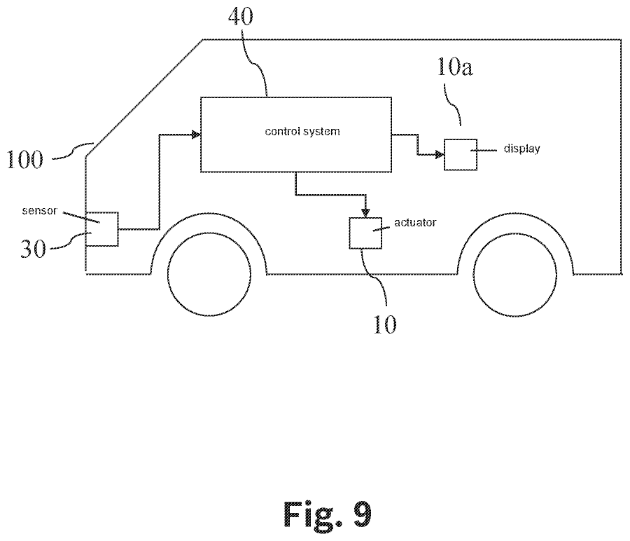

FIG. 9 shows how control system 40 may be used for controlling an at least semi-autonomous robot, here, of an at least semi-autonomous motor vehicle 100.

Sensor 30 may, for example, be a video sensor preferably situated in motor vehicle 100.

Artificial neural network 60 is configured to reliably identify objects from input images x.

Actuator 10 preferably situated in motor vehicle 100 may, for example, be a brake, a drive or a steering of motor vehicle 100. Activation signal A may be ascertained in such a way that the actuator or actuators 10 is/are activated in such a way that motor vehicle 100 prevents, for example, a collision with the objects reliably identified by artificial neural network 60, in particular, if it involves objects of particular classes, for example, pedestrians.

Alternatively, the at least one semi-autonomous robot may also be another mobile robot (not depicted), for example, one which moves by flying, floating, diving or pacing. The mobile robot may, for example, also be an at least semi-autonomous lawn mower or an at least semi-autonomous cleaning robot. In these cases as well, activation signal A may be ascertained in such a way that the drive and/or steering of the mobile robot may be activated in such a way that the at least semi-autonomous robot prevents, for example, a collision with objects identified by artificial neural network 60.

Alternatively or in addition, display unit 10a may be activated with activation signal A and, for example, the ascertained safe areas may be shown. It is also possible, for example, in a motor vehicle 100 with non-automated steering, that display unit 10a is activated with activation signal A in such a way that it outputs a visual or acoustic warning signal if it is ascertained that motor vehicle 100 threatens to collide with one of the reliably identified objects.

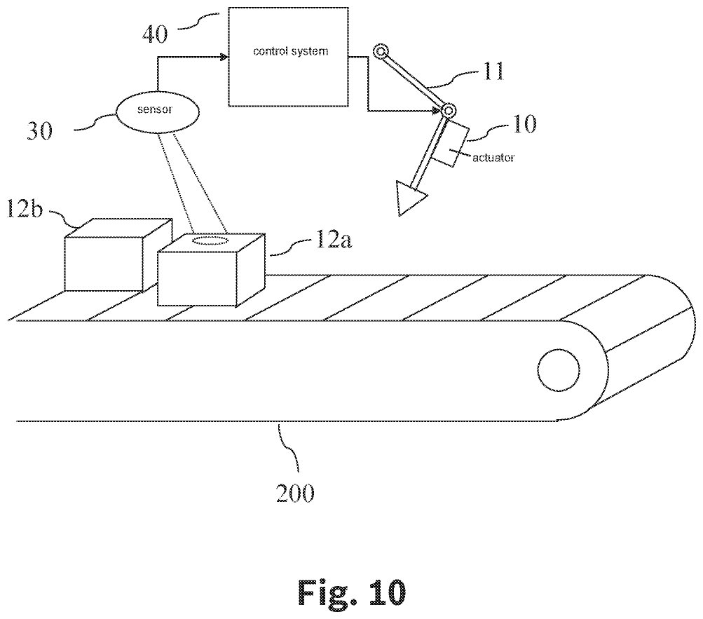

FIG. 10 shows one exemplary embodiment, in which control system 40 is used for activating a manufacturing machine 11 of a manufacturing system 200 by activating an actuator 10 controlling this manufacturing machine 11. Manufacturing machine 11 may, for example, be a machine for stamping, sawing, drilling and/or cutting.

Sensor 30 may then, for example, be an optical sensor, which detects, for example, properties of manufactured products 12a, 12b. It is possible that these manufactured products 12a, 12b are movable. It is possible that actuator 10 controlling manufacturing machine 11 is activated as a function of an assignment of detected manufactured products 12a, 12b, so that manufacturing machine 11 accordingly carries out a subsequent processing step of the correct one of manufactured products 12a, 12b. It is also possible that by identifying the correct properties of the same one of manufactured products 12a, 12b (i.e., without a misclassification), manufacturing machine 11 accordingly adapts the same manufacturing step for a processing of a subsequent manufactured product.

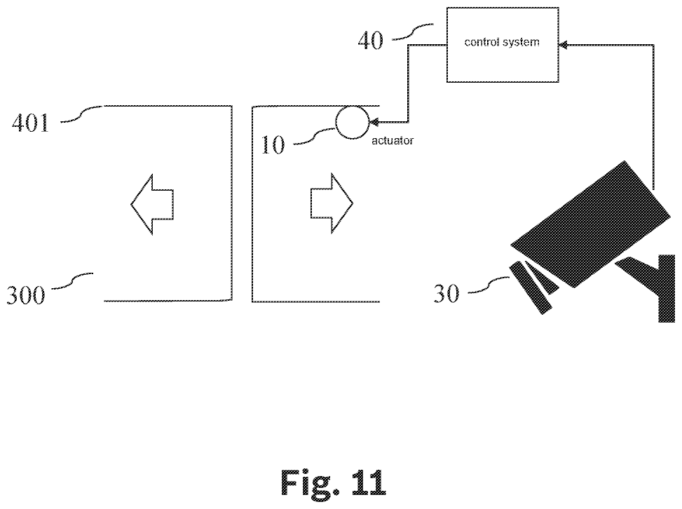

FIG. 11 shows one exemplary embodiment, in which control system 40 is used for controlling an access system 300. Access system 300 may include a physical access control, for example, a door 401. Video sensor 30 is configured to detect a person. This detected image may be interpreted with the aid of object identification system 60. If multiple persons are detected simultaneously, it is possible to particularly reliable ascertain the identity of the persons by an assignment of the persons (i.e., of the objects) relative to one another, for example, by an analysis of their movements. Actuator 10 may be a lock, which releases or does not release the access control as a function of activation signal A, for example, opens or does not open door 401. For this purpose, activation signal A may be selected as a function of the interpretation of object identification system 60, for example as a function of the ascertained identity of the person. Instead of the physical access control, a logical access control may also be provided.

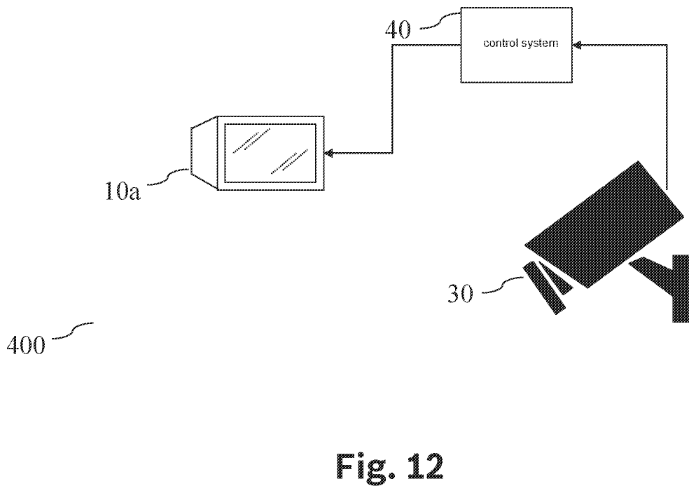

FIG. 12 shows one exemplary embodiment, in which control system 40 is used for controlling a monitoring system 400. This exemplary embodiment differs from the exemplary embodiment represented in FIG. 5 in that instead of actuator 10, display unit 10a is provided, which is activated by control system 40. For example, an identity of the objects recorded by video sensor 30 may be reliably ascertained by artificial neural network 60, in order as a function thereof, for example, to conclude which become suspicious, and activation signal A is then selected in such a way that this object is displayed color-highlighted by display unit 10a.

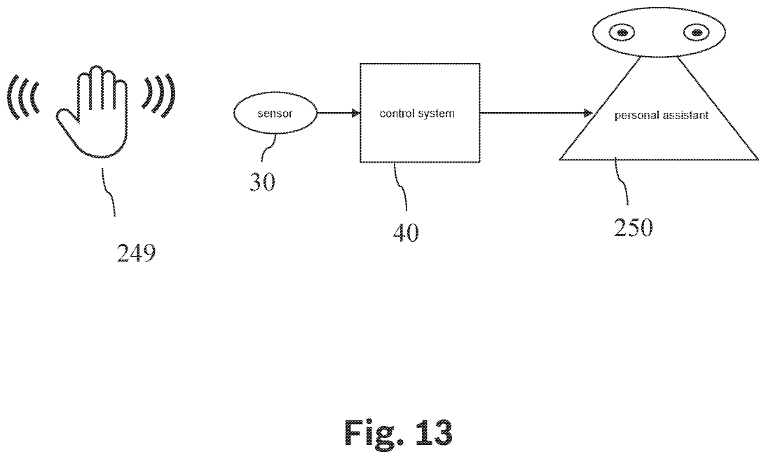

FIG. 13 shows one exemplary embodiment, in which control system 40 is used for controlling a personal assistant 250. Sensor 30 is preferably an optical sensor, which receives images of a gesture of a user 249.

Control system 40 ascertains as a function of the signals of sensor 30 an activation signal A of personal assistant 250, for example, by the neural network carrying out a gesture recognition. This ascertained activation signal A is then conveyed to personal assistant 250 and it is thus activated accordingly. This ascertained activation signal A may be selected, in particular, in such a way that it corresponds to a presumed desired activation by user 249. This presumed desired activation may be ascertained as a function of the gesture recognized by artificial neural network 60. Control system 40 may then select activation signal A as a function of the presumed desired activation for the conveyance to personal assistant 250 and/or may select activation signal A for the conveyance to the personal assistant corresponding to presumed desired activation 250.

This corresponding activation may, for example, entail personal assistant 250 retrieving pieces of information from a database and intelligibly reproducing these for user 249.

Instead of personal assistant 250, a household appliance (not depicted), in particular, a washing machine, a stove, an oven, a microwave or a dishwasher may also be provided in order to be activated accordingly.

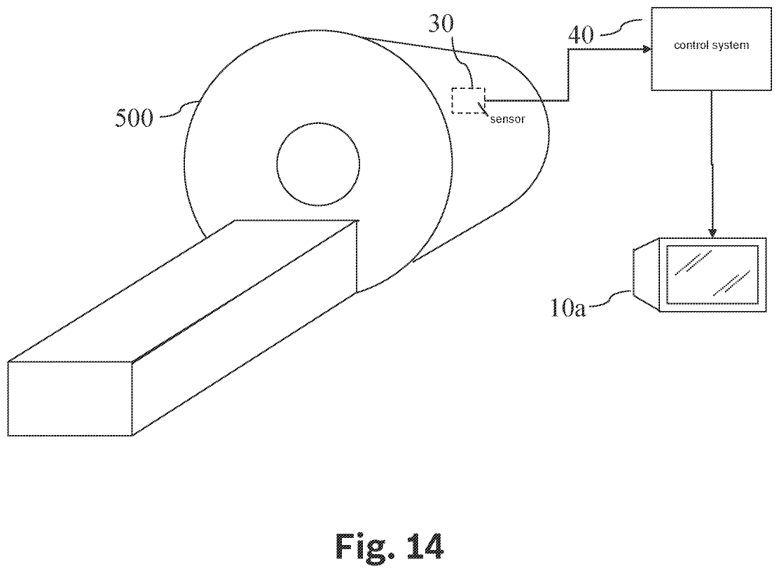

FIG. 14 shows one exemplary embodiment, in which control system 40 is used for controlling a medical imaging system 500, for example, an MRT device, X-ray device or ultrasound device. Sensor 30 may, for example, be provided as an imaging sensor, display unit 10a is activated by control system 40. For example, it may be ascertained by neural network 60 whether an area recorded by the imaging sensor is striking, and activation signal A is then selected in such a way that this area is displayed color-highlighted by display unit 10a.

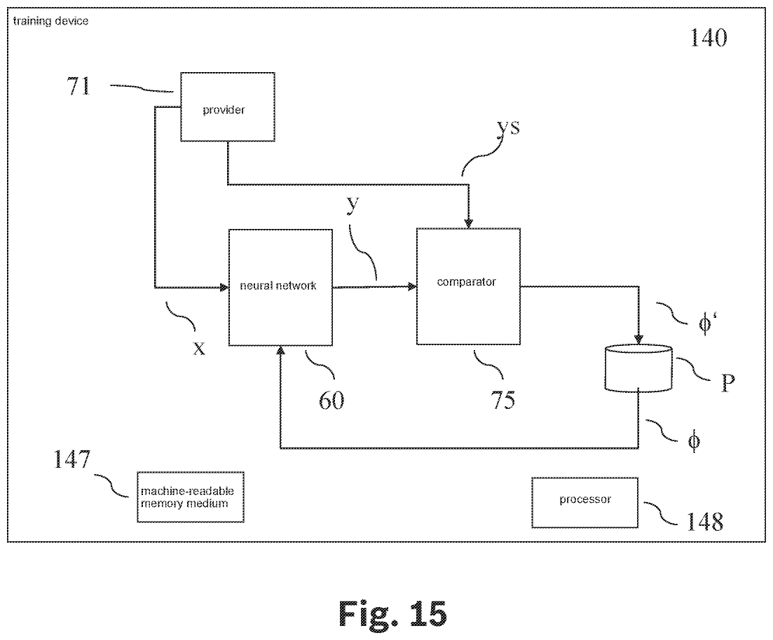

FIG. 15 shows an exemplary training device 140 for training a drawn machine learning system from graph G, in particular, of corresponding neural network 60. Training device 140 includes a provider 71, which provides, for example, input images x and setpoint output images ys, for example, setpoint classifications. Input image x is fed to artificial neural network 60 to be trained, which ascertains therefrom output variables y. Output variables y and setpoint variables ys are fed to a comparator 75, which ascertains therefrom new parameters ϕ′, as a function of a correspondence, of respective output variables y and setpoint variables ys, which are conveyed to parameter memory P where they replace parameters ϕ.

The methods carried out by training system 140 implemented as computer program may be stored on a machine-readable memory medium 147 and carried out by a processor 148.

It is, of course, not necessary to classify whole images. It is possible that, for example, image details are classified as objects using a detection algorithm, that these image details are then cut out, optionally a new image detail is generated and used in the associated image instead of the cut out image detail.

The term “computer” includes arbitrary devices for processing predefinable calculation rules. These calculation rules may be present in the form of software or in the form of hardware or also in a mixture of software and hardware.

What is claimed is:

1. A computer-implemented method for creating a machine learning system, which is configured for segmentation and object description, the machine learning system including an input for receiving an image and two outputs, a first output outputting the segmentation of the image and a second output outputting the object description, comprising the following steps:
providing a directed graph, the directed graph including an input node, an output node, and a plurality of further nodes, the input node and the output node being connected via the further nodes using directed edges, the input, output, and further nodes representing data and the edges representing operations, which convert a first node of each respective edge into a further node connected to the respective edge, each respective edge of the edges being assigned a probability which characterizes with which probability the respective edge is selected;
selecting a path through the graph, a subset of nodes being determined from the plurality of further nodes, all of which satisfy a predefined property with respect to a data resolution, at least one additional node being selected from the subset, which serves as a second output, the path through the graph from the input node along the edges via the additional node up to the output node being selected as a function of the probability assigned to the edges;
creating a machine learning system as a function of the selected path and training the created machine learning system, adapted parameters of the trained machine learning system being stored in the corresponding edges of the directed graph and the probabilities of the edges of the path being adapted;
multiple repeating of the selecting a path step and the creating and training a machine learning system step; and
creating the machine learning system as a function of the directed graph;
wherein the probabilities of the edges are set initially to one value, so that all paths through the directed graph are selected with equal probability.

2. The method as recited in claim 1, wherein for each respective node of the subset, a total number of first subpaths from the respective node of the subset up to the input node and a total number of second subpaths from the respective node of the subset up to the output node are counted, the probabilities of those edges contained in the first subpaths are each initially set to a number of possible paths which connect the input node to the respective node of the subset and extend over those edges contained in the first subpaths, divided by the total number of the first subpaths, and the probabilities of those edges contained in the second subpaths are each initially set to a number of possible paths which connect the output node to the respective node of the subset and extend over those edges contained in the second subpaths, divided by the total number of the second subpaths.

3. The method as recited in claim 1, wherein the nodes of the subset, which all satisfy a predefined property with respect to a data resolution, are each also assigned a probability, the probabilities of the nodes of the subset being normalized.

4. The method as recited in claim 3, wherein the probabilities of the nodes of the subset are initially set to a probability that the number of paths is set by the respective node of the subset divided by the total number of paths through the directed graph.

5. The method as recited in claim 3, wherein the probabilities of the nodes of the subset are initially set to a probability that all nodes of the subset are initially selected with equal probability.

6. The method as recited in claim 1, wherein when selecting the path, at least two additional nodes are selected, a path through the graph including at least two paths, each of which extends via one of the additional nodes to the output node, and the two paths from the input node to the additional nodes being created separately from one another starting at the additional nodes up to the input node.

7. The method as recited in claim 1, wherein during training of the machine learning system, a cost function is optimized, the cost function including one first function, which evaluates an efficiency of the machine learning system with respect to its outputs, and includes one second function, which estimates a latency and/or a computer resource consumption of the machine learning system as a function of a length of the path and of the operations of the edges.

8. A non-transitory machine-readable memory element on which is stored a computer program for creating a machine learning system, which is configured for segmentation and object description, the machine learning system including an input for receiving an image and two outputs, a first output outputting the segmentation of the image and a second output outputting the object description, the computer program, when executed by a computer, causing the computer to perform the following steps:
providing a directed graph, the directed graph including an input node, an output node, and a plurality of further nodes, the input node and the output node being connected via the further nodes using directed edges, the input, output, and further nodes representing data and the edges representing operations, which convert a first node of each respective edge into a further node connected to the respective edge, each respective edge of the edges being assigned a probability which characterizes with which probability the respective edge is selected;
selecting a path through the graph, a subset of nodes being determined from the plurality of further nodes, all of which satisfy a predefined property with respect to a data resolution, at least one additional node being selected from the subset, which serves as a second output, the path through the graph from the input node along the edges via the additional node up to the output node being selected as a function of the probability assigned to the edges;
creating a machine learning system as a function of the selected path and training the created machine learning system, adapted parameters of the trained machine learning system being stored in the corresponding edges of the directed graph and the probabilities of the edges of the path being adapted;
multiple repeating of the selecting a path step and the creating and training a machine learning system step; and
creating the machine learning system as a function of the directed graph;
wherein the probabilities of the edges are set initially to one value, so that all paths through the directed graph are selected with equal probability.

9. A device configured to create a machine learning system, which is configured for segmentation and object description, the machine learning system including an input for receiving an image and two outputs, a first output outputting the segmentation of the image and a second output outputting the object description, the device configured to:
provide a directed graph, the directed graph including an input node, an output node, and a plurality of further nodes, the input node and the output node being connected via the further nodes using directed edges, the input, output, and further nodes representing data and the edges representing operations, which convert a first node of each respective edge into a further node connected to the respective edge, each respective edge of the edges being assigned a probability which characterizes with which probability the respective edge is selected;
select a path through the graph, a subset of nodes being determined from the plurality of further nodes, all of which satisfy a predefined property with respect to a data resolution, at least one additional node being selected from the subset, which serves as a second output, the path through the graph from the input node along the edges via the additional node up to the output node being selected as a function of the probability assigned to the edges;
create a machine learning system as a function of the selected path and train the created machine learning system, adapted parameters of the trained machine learning system being stored in the corresponding edges of the directed graph and the probabilities of the edges of the path being adapted;
multiple repeating of the selection of the path and the creation and training of a machine learning system; and
create the machine learning system as a function of the directed graph;
wherein the probabilities of the edges are set initially to one value, so that all paths through the directed graph are selected with equal probability.
